(19) United States
(12) Patent Application Publication
(10) Pub. No.: US 2006/0153065 A1
(43) Pub. Date: Jul. 13, 2006

(54) Point-of-sales terminal, failure information display method and failure information display program

(75) Inventor: Kaname Nihei, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/304,808

(22) Filed: Dec. 16, 2005

(30) Foreign Application Priority Data
Jan. 7, 2005 (JP) 2005-002498

(51) Int. Cl. H04J 1/16

(52) U.S. Cl. 370/216

(57) ABSTRACT

According to the present invention, information is provided about the result of determination of whether or not a detected failure is a failure which can be responded to, based on comparison between the failure level of the detected failure and a failure response level which has been arbitrarily set. This information enables a salesperson to determine whether or not to respond to the occurred failure himself and quickly determine whether to respond to the failure himself or to call a maintenance staff member, and thereby it is possible to avoid giving trouble to a customer. In addition, since the content itself of the detected failure is not displayed as has been done conventionally, the customer who sees the information does not feel uncomfortable.

### BACKGROUND OF THE INVENTION

1. Field of the Invention

The present invention relates to a point-of-sales terminal, a failure information display method and a failure information display program, and in particular to a technique for giving information about a failure which has occurred in a point-of-sales terminal.

2. Description of the Related Art

There have been developed techniques for notifying information about equipment maintenance. For example, the software disclosed in Japanese Patent Application Laid-Open No. 2003-186508 is software for maintenance management to be added to and integrated with software for control of drive in a computer-controlled apparatus which includes a wearing portion that wears or deteriorates in performance, and the software is provided with a storage device which stores a setting value of the wearing portion, a deterioration counter which gives information about the degree of wearing or performance deterioration of the wearing portion, and a maintenance limitation informing device which compares the count value of the deterioration counter with the setting value stored by the storage device and gives information about the endurance limit.

### SUMMARY OF THE INVENTION

In recent years, various point-of-sales terminals have widely spread, such as a point-of-sales print apparatus to be installed at the storefront of various stores for printing images brought there by customers. However, there may be a case where paper-out condition or a machine trouble is caused during an operation by a customer and the service is stopped. In this case, a salesperson staying at the storefront primarily responds to such a trouble. However, in some cases, the salesperson cannot immediately determine whether or not the trouble is actually such as he can cope with. If it takes much time to determine whether the salesperson himself should respond thereto or it is necessary to call a maintenance staff member, it will be an annoyance to the customer the service for whom has been terminated. Furthermore, if the service is not resumed immediately, other customers waiting for using the service will also be annoyed.

It is conceivable to display detailed maintenance information as in Japanese Patent Application Laid-Open No. 2003-186508 in order to solve such a problem. However, such information will be uncomfortable to the customer who is not responsible for maintenance. The present invention has been made in consideration of such problems, and the object thereof is to inform a customer of the content of an occurred failure without giving uncomfortableness to the customer.

In order to solve the above problem, a point-of-sales terminal according to the present invention comprises: a detection section which detects a failure of hardware or software constituting the points-of-sales terminal; a failure level storage section which stores, for each of failures to be detected by the detection section, a failure level indicating the degree of difficulty in responding to the failure; a failure response level setting section which accepts, for each of the failures to be detected by the detection section, setting of a failure response level indicating the degree of possibility of responding to the failure; a determination section which, when a failure is detected by the detection section, determines whether or not the detected failure is a failure to be responded to, based on comparison with a failure level corresponding to the failure and a failure response level set for the failure; and a display section which displays information corresponding to the result of the determination.

According to the point-of-sales terminal of the present invention, information is provided about the result of determination of whether or not a detected failure is a failure which can be responded to, based on comparison between the failure level of the detected failure and a failure response level which has been arbitrarily set. This information enables a salesperson to determine whether or not to respond to the occurred failure himself and quickly determine whether to respond to the failure himself or to call a maintenance staff member, and thereby it is possible to avoid giving trouble to a customer. In addition, since the content itself of the detected failure is not displayed as has been done conventionally, the customer who sees the information does not feel uncomfortable.

The point-of-sales terminal may further comprise a failure level setting section which accepts the setting of the failure levels, and the failure level storage section may be adapted to store the set failure levels from the failure level setting section.

The setting of the failure levels may be performed in advance before shipment of the point-of-sales terminal or may be adapted to be freely performed by a salesperson of a store where the point-of-sales terminal is installed.

In the point-of-sales terminal of the present invention, the failure levels to be accepted by the failure level setting section may include a first failure level indicating a level at which it is necessary to call a maintenance staff member, a second failure level indicating a level at which a salesperson familiar with system failures to some extent is able to respond, and a third failure level at which a salesperson having some knowledge about response to an elementary system failure; and the failure response levels to be accepted by the failure response level setting section may include a first failure response level indicating the level of a salesperson who is able to respond to system failures, a second failure response level indicating the level of a salesperson who is able to respond to an elementary system failure, and a third failure response level indicating the level of a salesperson who is not able to respond to a failure at all.

The determination section may be adapted to determine that the detected failure is not a failure to be responded to if a failure level corresponding to the detected failure is the first failure level.

The determination section may be adapted to determine that the detected failure is not a failure to be responded to if a failure level corresponding to the detected failure is the second failure level and a failure response level corresponding to the detected failure is the second failure response level or the third failure response level.

The display section may be adapted to display information to the effect that a service by the point-of-sales terminal is to be stopped if a detected failure is determined to be a failure which cannot be responded to. If a salesperson sees this display, he can recognize that a failure at a level which he cannot respond to has occurred.

The determination section may be adapted to determine that the detected failure is a failure to be responded to if a failure level corresponding to the detected failure is the second failure level or the third failure level and a failure response level corresponding to the detected failure is the first failure response level.

The determination section may be adapted to determine that the detected failure is a failure to be responded, to if a failure level corresponding to the detected failure is the third failure level and a failure response level corresponding to the detected failure is the first failure response level or the second failure response level.

The display section may be adapted to display information to the effect that it is necessary to call the salesperson if a detected failure is determined to be a failure which can be responded to. If a salesperson sees this display, he can recognize that a failure at a level which he can respond to has occurred.

The failure detected by the detection section is paper-out condition of a printer, change-out condition of a coin machine, receipt-paper-out condition, a touch panel failure, a printer failure, a coin machine failure, a receipt printer failure, a recording medium failure, a hardware failure or a software error.

When the point-of-sales terminal is a point-of-sales print apparatus, its detection section detects the failures as described above as examples. The point-of-sales terminal of the present invention is not limited to the point-of-sales print apparatus, and there are included various point-of-sales terminals such as an ATM, a CD, a kiosk and an automatic ticket vending machine. The detection section may detect other failures in addition to the failures described above, and it goes without saying that detectable failures are varied depending on the hardware configuration or the software configuration of the point-of-sales terminal.

A failure information display method according to the present invention comprises the steps of: detecting a failure of hardware or software constituting the points-of-sales terminal; storing, for each of failures to be detected by the detection section, a failure level indicating the degree of difficulty in responding to the failure; accepting, for each of the failures to be detected by the detection section, setting of a failure response level indicating the degree of possibility of responding to the failure; when a failure is detected by the detection section, determining whether or not the detected failure is a failure to be responded to, based on comparison with a failure level corresponding to the failure and a failure response level set for the failure; and displaying information corresponding to the result of the determination.

The failure information display method can be performed on various point-of-sales information terminals such as a point-of-sales print apparatus, an ATM, a CD, a kiosk and an automatic ticket vending machine.

An failure information display program according to the present invention causes a computer to perform the steps of: detecting a failure of hardware or software constituting the points-of-sales terminal; storing, for each of failures to be detected by the detection section, a failure level indicating the degree of difficulty in responding to the failure; accepting, for each of the failures to be detected by the detection section, setting of a failure response level indicating the degree of possibility of responding to the failure; when a failure is detected by the detection section, determining whether or not the detected failure is a failure to be responded to, based on comparison with a failure level corresponding to the failure and a failure response level set for the failure; and displaying information corresponding to the result of the determination.

The failure information display program is executed by various operation devices, such as a CPU provided for a point-of-sales terminal.

According to the present invention, information is provided about the result of determination of whether or not a detected failure is a failure which can be responded to, based on comparison between the failure level of the detected failure and the failure response level of a salesperson. This information enables the salesperson to determine whether or not he can respond to the occurred failure and quickly determine whether to respond to the failure himself or to call a maintenance staff member, and thereby it is possible to avoid giving trouble to a customer. In addition, since the content itself of the detected failure is not displayed as has be en done conventionally, the customer who sees the information does not feel uncomfortable.

### BRIEF DESCRIPTION OF THE DRAWINGS

FIG. 1 is a front view of a point-of-sales print apparatus according to a preferred embodiment of the present invention;

FIG. 2 is a block diagram of the point-of-sales print apparatus;

FIG. 3 is a flowchart showing the flow of printing operation;

FIG. 4 shows an example of failure items;

FIG. 5 shows an example of failure levels set corresponding to the failure items;

FIG. 6 shows a display example of a failure level setting screen;

FIG. 7 shows a display example of the failure level setting screen;

FIG. 8 shows a display example of a failure response level setting screen (uniform setting);

FIG. 9 shows a display example of the failure response level setting screen (individual setting);

FIG. 10 shows a display example of the failure response level setting screen (individual setting);

FIG. 11 is a flowchart showing the flow of failure information screen display operation;

FIG. 12 shows a display example of a service stop screen; and

FIG. 13 shows a display example of a salesperson calling screen.

### DETAILED DESCRIPTION OF THE PREFERRED EMBODIMENTS

A preferred embodiment of the present invention will be described below with reference to accompanying drawings.

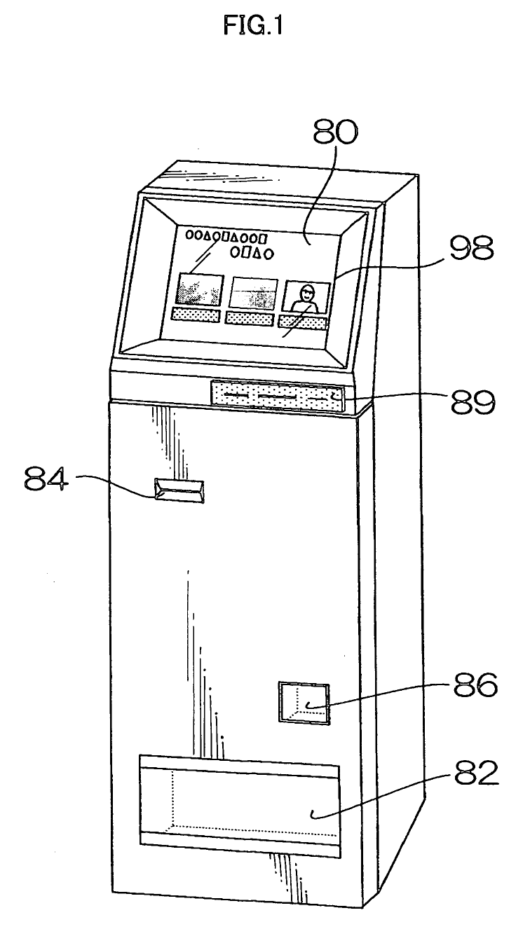

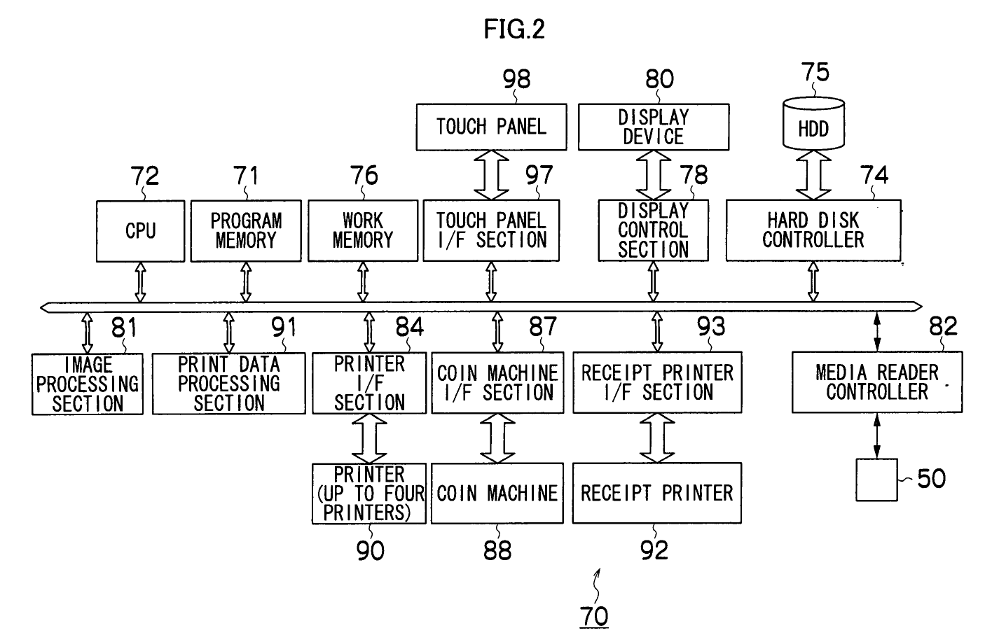

FIG. 1 is a front view of a point-of-sales print apparatus 70 according to the present invention. The point-of-sales print apparatus 70 is a machine to be used by a customer for inserting a recording medium 50 (see FIG. 2), such as a SmartMedia, into an insertion port 89 and throwing money to print a digital image stored in the recording medium 50 on a print medium such as TA paper. The point-of-sales print apparatus 70 is a point-of-sales information terminal installed at the storefront of various stores such as a photo shop, a bookstore and a supermarket and is ordinarily used by a customer who purchases a print for himself without assistance by a salesperson. When an abnormality occurs in the point-of-sales print apparatus 70, the customer calls a salesperson of the store where the point-of-sales print apparatus 70 is installed or a specialized maintenance staff member to cope with the abnormality.

On the point-of-sales print apparatus 70, there is arranged a liquid crystal display device 80 with a touch panel 98 laminated in the front thereof. While looking at the liquid crystal display device 80, the customer operates the touch panel 98 to input necessary information such as the print size and the number of prints. Inside the point-of-sales print apparatus 70, there are installed one or more printers 90 (see FIG. 2) so that each of the printers 90 can print a digital image. There are arranged up to four printers 90 in the point-of-sales print apparatus 70 of the present embodiment. At the external front of the point-of-sales-print apparatus 70, there is provided a discharge port 83 from which a printed print medium is to be discharged. Furthermore, there are also provided a coin slot 85 through which coins are to be thrown into a coin machine 88 to be described later and a return slot 86 from which change is to be returned by the coin machine 88.

FIG. 2 is a block diagram showing the hardware configuration of the point-of-sales print apparatus 70.

When a customer inserts the recording medium 50 into the insertion port 89, a hard disk controller 74 loads control software recorded in a hard disk (HDD) 75 to a program memory 71. Image data which is compressed in a predetermined format is recorded in the recording medium 50. When obtaining desired image data from the recording medium 50 by instructing a media reader controller 82 to read the image data, a CPU 72 expands the image data to restore it to the original image data by means of an image processing section 81, and then, it performs desired image processing by means of the image processing section 81 and causes the image data to be stored in a work memory 76.

By the customer pressing a desired position on the touch panel 98, the necessary information such as the print size and the number of prints is converted to an electric signal corresponding to the position and inputted to the CPU 72 via a touch panel interface section 97. The inputted information is displayed on the display device 80. The display device 80 is operated by a display control section 78. The coin machine 88 converts the amount displayed on the display device 80 based on the information inputted from the touch panel 98 to an electric signal and inputs it to the CPU 72 via a coin machine I/F section 87. The CPU 72 checks whether the customer has thrown a necessary amount of money. If the necessary amount has been thrown, a print data processing section 91 creates print job data from the image data stored in the work memory 76 and sends the print job data to each printer 90 via a printer I/F section 84. The sequence of these controls is performed by the CPU 72.

A printing method referred to a TA method is adopted by each printer 90, and TA paper is used which has characteristics that it is colored by being heated and that the colors are fixed by the paper being exposed to light with a predetermined wave length.

When printing is finished, a receipt on which the amount thrown into the coin machine 88 and the amount of returned change are described is outputted from a receipt printer 92. The content to be printed by the receipt printer 92 is specified by the CPU 72 via a receipt printer I/F section 93.

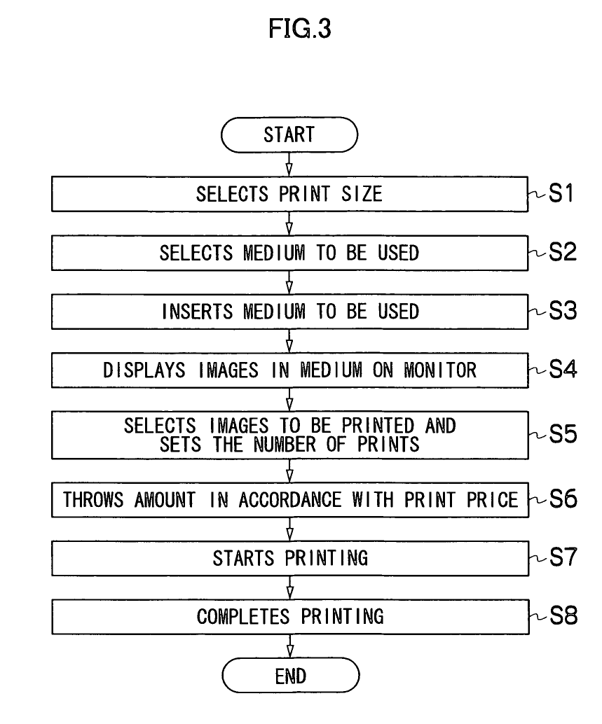

FIG. 3 is a flowchart summarizing the printing operation to be normally performed by the point-of-sales print apparatus 70.

First, a customer selects the size of an image to be printed (S1) and selects the kind of the recording medium 50 (S2) by pressing the display portion of a graphical user interface (GUI) displayed on the display device 80. After selection of these items, the customer inserts a recording medium 50 into the insertion port 89 (S3). Images read from the recording medium 50 are displayed on the display device 80 (S4).

Through the GUI, the customer selects images to be printed and sets the number of prints for each image (S5). The CPU 72 calculates the print price from the number of images to be printed, displays the print price on the display device 80 and waits for the amount to be thrown. The customer throws the amount required for paying the print price (S6), and printing is started when the required amount has been thrown (S7). When printing is completed, print medium on which the images are printed are discharged from the discharge port 83. The sequence of operations S1 to S8 are repeated as necessary, for example, in the case of continuing printing of another image.

The CPU 72 executes an RAS (reliability, availability, scalability) function of monitoring failure condition of hardware and software constituting the point-of-sales print apparatus 70 and detecting occurrence of a failure in each section. In the present embodiment, the CPU 72 detects a hardware failure of the touch panel 98, the touch panel I/F section 97, the display device 80, the display control section 78, the hard disk 75, the hard disk controller 74, the media reader controller 82, the receipt printer I/F section 93, the receipt printer 92, the coin machine I/F section 87, the coin machine 88, the printer I/F section 84, the printers 90, the print data processing section 91, the image processing section 81, the program memory 71 and the work memory 76. Furthermore, the CPU 72 also has a watch dog timer function of detecting operation abnormality of various programs to be loaded onto the program memory 71 and operated by the CPU 72. In addition, the CPU 72 may have a function of detecting various failures which may occur in the point-of-sales print apparatus 70, such as stop of rotation of a cooling fan not shown, abnormality of temperature inside the body and abnormality of power supply voltage.

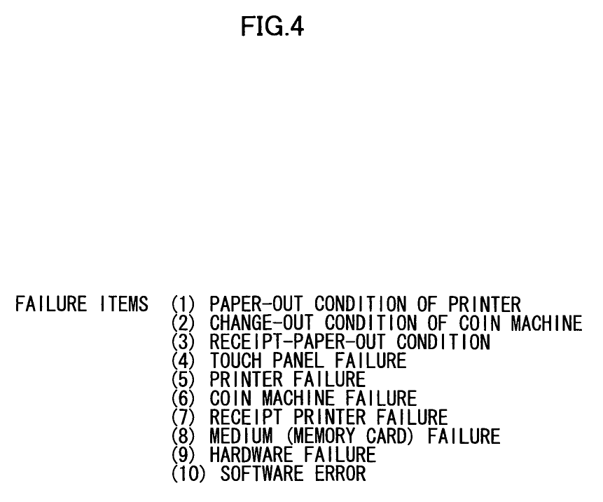

The CPU 72 classifies detected failures into items and stores them in the work memory 76 or the HDD 75. FIG. 4 shows an example of failure items. 1) paper-out condition indicates paper-out condition of a printer 90, 2) change-out condition of coin machine indicates change-out condition of the coin machine 88, 3) receipt-paper-out condition indicates receipt-paper-out condition of the receipt printer 92, 4) touch panel failure indicates a failure of the touch panel 98, 5) printer failure indicates any failure of a printer 90 other than paper-out condition, 6) coin machine failure indicates any failure of the coin machine 88 other than coin-out condition, 7) receipt printer failure indicates any failure of the receipt printer 92 other than receipt-paper-out condition, 8) medium (memory card) failure indicates a failure of the recording medium 50, 9) hardware failure indicates a failure of the CPU 72, the program memory 71, the work memory 76, the hard disk controller 74, the HDD 75, the image processing section 81 or the print data processing section 91, and 10) software error indicates operation abnormality of a program operated by the CPU 72.

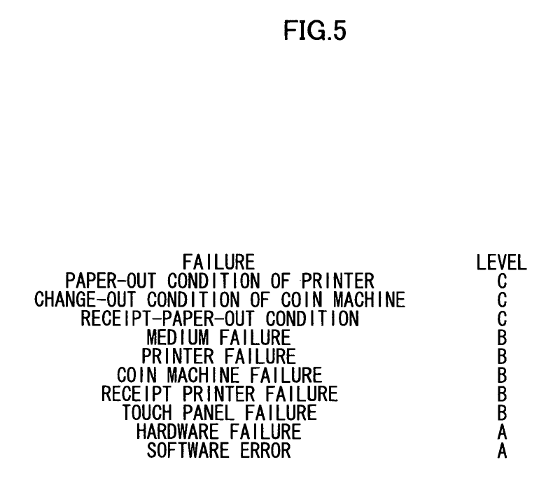

In the point-of-sales print apparatus 70 of the present embodiment, a failure level corresponding to each failure item is set in advance, which indicates the degree of difficulty of the failure item. The failure level corresponding to each failure item is stored in the HDD 75. FIG. 5 shows an example of correspondence between the failure items and the failure levels. Level A indicates the highest difficulty level, and the degree of difficulty is gradually lower for levels B, C and so on. As guides for setting failure levels, the failure level A is assumed to indicate a failure level requiring calling a maintenance staff member; the failure level B is assumed to indicate a failure level that a salesperson familiar to system failures to some extent can respond; and the failure level C is assumed to indicate a failure level that a salesperson with some knowledge to cope with an elementary system failure can respond.

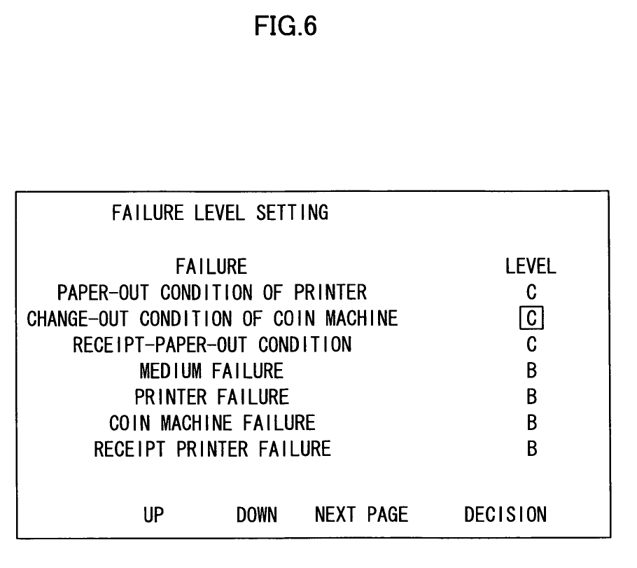

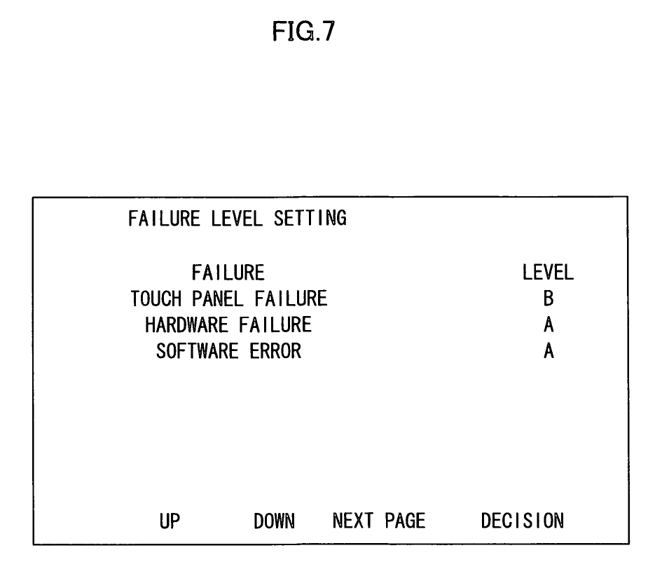

The correspondence between the failure items and the failure levels may be stored in the HDD 75 in advance before shipment, or it may be adapted to be freely set by an employee of a store where the point-of-sales print apparatus 70 is installed. In this case, a failure level setting screen is provided as a maintenance screen different from a screen to be usually operated by a customer for ordering prints so that the salesperson can freely set failure levels by operating the GUI on the failure level setting screen with the touch panel 98. FIGS. 6 and 7 are display examples of the failure level setting screen.

In the point-of-sales print apparatus 70 of the present embodiment, it is possible to set a salesperson response level for each failure item. In this case, a failure response level setting screen is provided as a maintenance screen different from the screen to be usually operated by a customer for ordering prints so that the salesperson can freely set failure response levels by operating the GUI on the failure level response level setting screen with the touch panel 98. The failure response levels indicate the degree of possibility for the salesperson to respond to a failure by stages, and guides for setting the failure response levels are such as are lower than the guides for setting the failure levels A to C by one stage. That is, a failure response level A indicates the level of a salesperson who can respond to a system failure; a failure response level B is the level of a salesperson who can respond to an elementary system failure; and a failure response level C indicates the level of a salesperson who cannot respond to a failure at all.

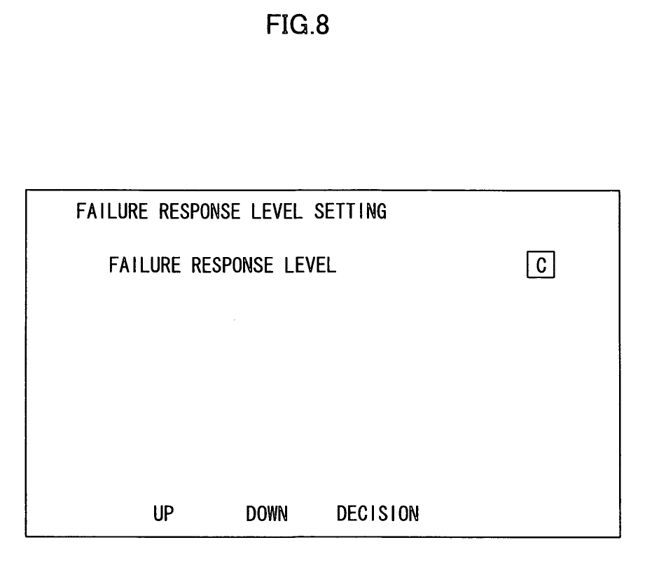

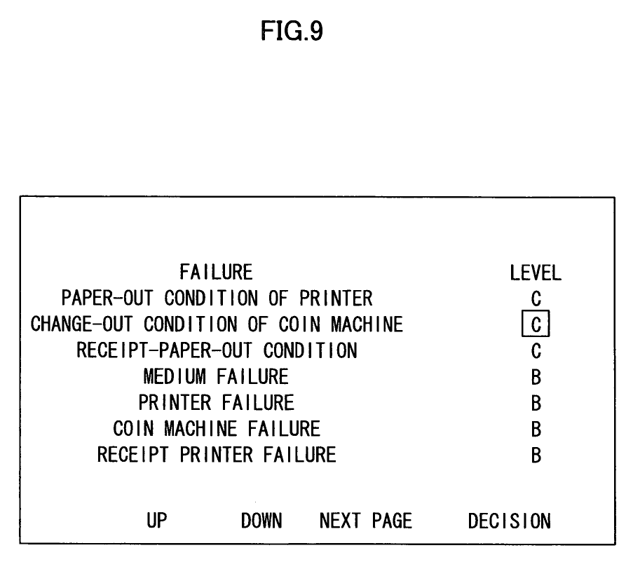

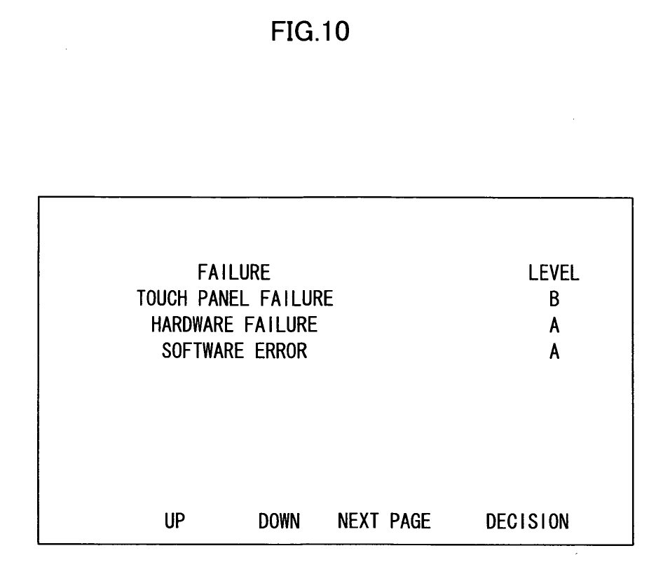

FIGS. 8 to 10 are display examples of the failure response level setting screen. As shown in FIG. 8, a failure response level may be uniformly set for all the failure items. Alternatively, as shown in FIGS. 9 and 10, a failure response level may be individually set for each failure item.

The point-of-sales print apparatus 70 of the present embodiment displays a failure information screen indicating whether a salesperson can respond to a detected failure, on the display device 80, based on comparison between the failure levels and the failure response levels set as described above.

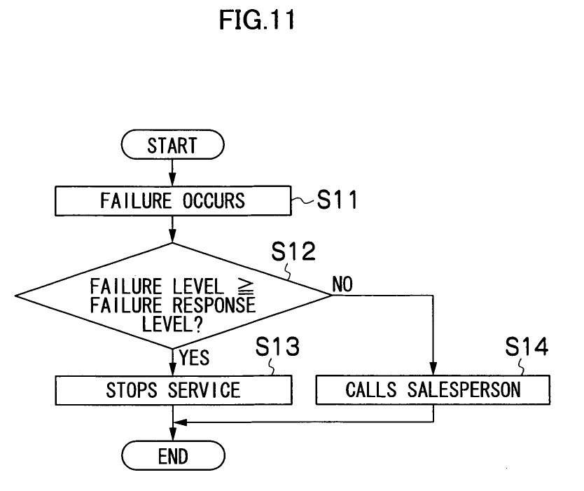

FIG. 11 is a flowchart showing the flow of operation of displaying the failure information screen. This operation is performed independently from the usual printing operation.

First, when the CPU 72 detects occurrence of a failure (S11), the occurred failure is classified into an item; a failure level corresponding to the failure item is identified from the HDD 75; and comparison is made between a failure level corresponding to the occurred failure and a failure response level set on the failure response level setting screen. Then, it is determined whether or not the failure level corresponding to the occurred failure is equal to or above the failure response level corresponding to the occurred failure (S12). In the case of “YES”, a service stop screen, which is a failure information screen displaying information to the effect that the service by the point-of-sales terminal is to be stopped, is displayed on the display device 80 (S13). In the case of “NO”, a salesperson calling screen, which is a failure information screen displaying information to the effect that it is necessary to call a salesperson, is displayed on the display device 80 (S14).

In following cases (Y1) and (Y2), the failure level corresponding to the occurred failure is determined to be “YES”, that is, equal to or above the failure response level corresponding to the occurred failure.
(Y1) When the failure level corresponding to the detected failure is the failure level A.
(Y2) When the failure level corresponding to the detected failure is the failure level B, and at the same time,
the failure response level corresponding to the detected failure is the failure response level B or the failure response level C.

On the other hand, in following cases (N1) and (N2), the failure level corresponding to the occurred failure is determined to be “NO”, that is, below the failure response level corresponding to the occurred failure.

(N1) When the failure level corresponding to the detected failure is the failure level B or the failure level C,

and at the same time,

the failure response level corresponding to the detected failure is the failure response level A.

(N2) When the failure level corresponding to the detected failure is the failure level C, and at the same time, the failure response level corresponding to the detected failure is the failure response level A or the failure response level B.

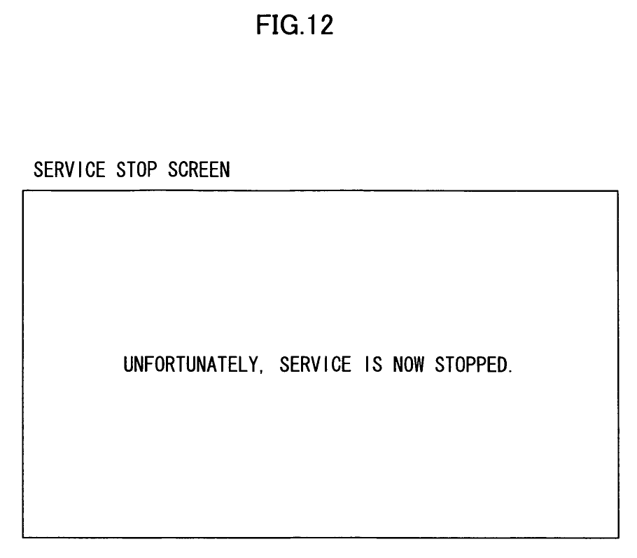

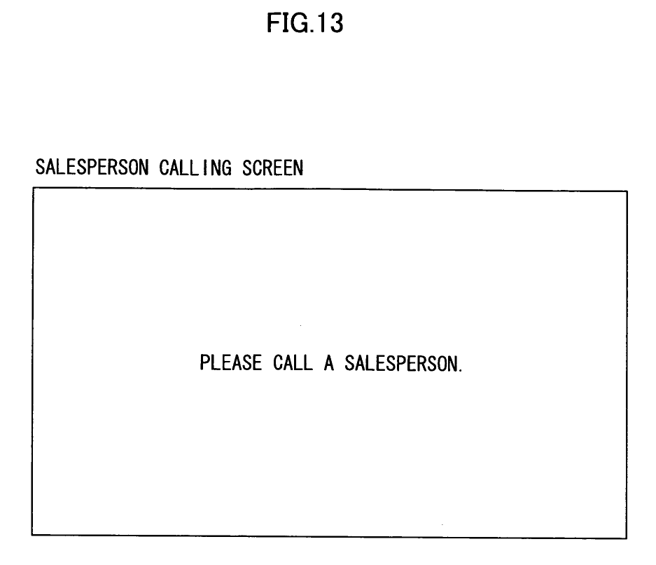

FIG. 12 is a display example of the service stop screen, and FIG. 13 is a display example of the salesperson calling screen. When the service stop screen or the salesperson calling screen is displayed while a general customer is ordering a print, the customer recognizes that some trouble has occurred in the point-of-sales print apparatus 70 and calls a salesperson. When the called salesperson sees the service stop screen, he can recognize that the occurred trouble is such as he cannot respond to and it is necessary to call a specialized maintenance staff member. If the called salesperson sees the salesperson calling screen, he can recognize that the occurred trouble is such as he can respond to, and he himself copes with the trouble appropriately.

Thus, the print apparatus according to the present embodiment is capable of informing a salesperson of the degree of a failure without explicitly showing the content of the failure. Conventionally, the content of a complicated failure is explicitly shown to a customer, and thereby the customer may feel uncomfortable. However, the print apparatus prevents such disadvantage and can urge the salesperson to suitably cope with the failure by showing him the degree of the failure, and thereby it contributes to improvement of customer service.

What is claimed is:

1. A point-of-sales terminal comprising:
a detection section which detects a failure of hardware or software constituting the points-of-sales terminal;
a failure level storage section which stores, for each of failures to be detected by the detection section, a failure level indicating the degree of difficulty in responding to the failure;
a failure response level setting section which accepts, for each of the failures to be detected by the detection section, setting of a failure response level indicating the degree of possibility of responding to the failure;
a determination section which, when a failure is detected by the detection section, determines whether or not the detected failure is a failure to be responded to, based on comparison with a failure level corresponding to the failure and a failure response level set for the failure; and
a display section which displays information corresponding to the result of the determination.

2. The point-of-sales terminal according to claim 1, further comprising a failure level setting section which accepts the setting of the failure levels,
wherein the failure level storage section stores the set failure levels from the failure level setting section.

3. The point-of-sales terminal according to claim 2, wherein
the failure levels to be accepted by the failure level setting section include a first failure level indicating a level at which it is necessary to call a maintenance staff member, a second failure level indicating a level at which a salesperson familiar with system failures to some extent is able to respond, and a third failure level at which a salesperson having some knowledge about response to an elementary system failure; and
the failure response levels to be accepted by the failure response level setting section include a first failure response level indicating the level of a salesperson who is able to respond to system failures, a second failure response level indicating the level of a salesperson who is able to respond to an elementary system failure, and a third failure response level indicating the level of a salesperson who is not able to respond to a failure at all.

4. The point-of-sales terminal according to claim 3, wherein the determination section determines that the detected failure is not a failure to be responded to if a failure level corresponding to the detected failure is the first failure level.

5. The point-of-sales terminal according to claim 3, wherein the determination section determines that the detected failure is not a failure to be responded to if a failure level corresponding to the detected failure is the second failure level and a failure response level corresponding to the detected failure is the second failure response level or the third failure response level.

6. The point-of-sales terminal according to claim 4, wherein the display section displays information to the effect that a service by the point-of-sales terminal is to be stopped.

7. The point-of-sales terminal according to claim 5, wherein the display section displays information to the effect that a service by the point-of-sales terminal is to be stopped.

8. The point-of-sales terminal according to claim 3, wherein the determination section determines that the detected failure is a failure to be responded to if a failure level corresponding to the detected failure is the second failure level or the third failure level and a failure response level corresponding to the detected failure is the first failure response level.

9. The point-of-sales terminal according to claim 3, wherein the determination section determines that the detected failure is a failure to be responded to if a failure level corresponding to the detected failure is the third failure level and a failure response level corresponding to the detected failure is the first failure response level or the second failure response level.

10. The point-of-sales terminal according to claim 8, wherein the display section displays information to the effect that it is necessary to call the salesperson.

11. The point-of-sales terminal according to claim 9, wherein the display section displays information to the effect that it is necessary to call the salesperson.

12. The point-of-sales terminal according to claim 1, wherein the failure detected by the detection section is paper-out condition of a printer, change-out condition of a coin machine, receipt-paper-out condition, a touch panel failure, a printer failure, a coin machine failure, a receipt printer failure, a recording medium failure, a hardware failure or a software error.

13. The point-of-sales terminal according to claim 2, wherein the failure detected by the detection section is paper-out condition of a printer, change-out condition of a coin machine, receipt-paper-out condition, a touch panel failure, a printer failure, a coin machine failure, a receipt printer failure, a recording medium failure, a hardware failure or a software error.

14. The point-of-sales terminal according to claim 3, wherein the failure detected by the detection section is paper-out condition of a printer, change-out condition of a coin machine, receipt-paper-out condition, a touch panel failure, a printer failure, a coin machine failure, a receipt printer failure, a recording medium failure, a hardware failure or a software error.

15. The point-of-sales terminal according to claim 4, wherein the failure detected by the detection section is paper-out condition of a printer, change-out condition of a coin machine, receipt-paper-out condition, a touch panel failure, a printer failure, a coin machine failure, a receipt printer failure, a recording medium failure, a hardware failure or a software error.

16. The point-of-sales terminal according to claim 5, wherein the failure detected by the detection section is paper-out condition of a printer, change-out condition of a coin machine, receipt-paper-out condition, a touch panel failure, a printer failure, a coin machine failure, a receipt printer failure, a recording medium failure, a hardware failure or a software error.

17. The point-of-sales terminal according to claim 6, wherein the failure detected by the detection section is paper-out condition of a printer, change-out condition of a coin machine, receipt-paper-out condition, a touch panel failure, a printer failure, a coin machine failure, a receipt printer failure, a recording medium failure, a hardware failure or a software error.

18. The point-of-sales terminal according to claim 7, wherein the failure detected by the detection section is paper-out condition of a printer, change-out condition of a coin machine, receipt-paper-out condition, a touch panel failure, a printer failure, a coin machine failure, a receipt printer failure, a recording medium failure, a hardware failure or a software error.

19. The point-of-sales terminal according to claim 8, wherein the failure detected by the detection section is paper-out condition of a printer, change-out condition of a coin machine, receipt-paper-out condition, a touch panel failure, a printer failure, a coin machine failure, a receipt printer failure, a recording medium failure, a hardware failure or a software error.

20. The point-of-sales terminal according to claim 9, wherein the failure detected by the detection section is paper-out condition of a printer, change-out condition of a coin machine, receipt-paper-out condition, a touch panel failure, a printer failure, a coin machine failure, a receipt printer failure, a recording medium failure, a hardware failure or a software error.

21. The point-of-sales terminal according to claim 10, wherein the failure detected by the detection section is paper-out condition of a printer, change-out condition of a coin machine, receipt-paper-out condition, a touch panel failure, a printer failure, a coin machine failure, a receipt printer failure, a recording medium failure, a hardware failure or a software error.

22. The point-of-sales terminal according to claim 11, wherein the failure detected by the detection section is paper-out condition of a printer, change-out condition of a coin machine, receipt-paper-out condition, a touch panel failure, a printer failure, a coin machine failure, a receipt printer failure, a recording medium failure, a hardware failure or a software error.

23. A failure information display method comprising the steps of:
detecting a failure of hardware or software constituting the points-of-sales terminal;
storing, for each of failures to be detected by the detection section, a failure level indicating the degree of difficulty in responding to the failure;
accepting, for each of the failures to be detected by the detection section, setting of a failure response level indicating the degree of possibility of responding to the failure;
when a failure is detected by the detection section, determining whether or not the detected failure is a failure to be responded to, based on comparison with a failure level corresponding to the failure and a failure response level set for the failure; and
displaying information corresponding to the result of the determination.

24. A failure information display program which causes a computer to perform the steps of:
detecting a failure of hardware or software constituting the points-of-sales terminal;
storing, for each of failures to be detected by the detection section, a failure level indicating the degree of difficulty in responding to the failure;
accepting, for each of the failures to be detected by the detection section, setting of a failure response level indicating the degree of possibility of responding to the failure;
when a failure is detected by the detection section, determining whether or not the detected failure is a failure to be responded to, based on comparison with a failure level corresponding to the failure and a failure response level set for the failure; and
displaying information corresponding to the result of the determination.
